(19) United States
(12) Patent Application Publication
(10) Pub. No.: US 2022/0121817 A1
(43) Pub. Date: Apr. 21, 2022

(54) INFORMATION PROCESSING DEVICE, INFORMATION PROCESSING METHOD, AND INFORMATION PROCESSING PROGRAM

(71) Applicant: SONY GROUP CORPORATION, Tokyo (JP)

(72) Inventors: SOTA MATSUZAWA, TOKYO (JP); TAMOTSU ISHII, TOKYO (JP); ATSUSHI NEGISHI, TOKYO (JP)

(21) Appl. No.: 17/428,667

(22) PCT Filed: Feb. 7, 2020
(86) PCT No.: PCT/JP2020/004721

§ 371 Date: Aug. 5, 2021

(30) Foreign Application Priority Data
Feb. 14, 2019 (JP) 2019-024161

(51) Int. Cl. G06F 40/274; G06F 3/023; G06F 40/279

(52) U.S. Cl. CPC G06F 40/274; G06F 40/279; G06F 3/0237

(57) ABSTRACT

An information processing device includes an end portion candidate determination unit configured to determine a plurality of candidates for an end portion that is added to an end of a body and forms a message along with the body.

### TECHNICAL FIELD

The present technology relates to an information processing device, an information processing method, and an information processing program.

### BACKGROUND ART

In recent years, as terminal devices such as smartphones have become widespread, it has become more common for users to send and receive messages.

Accordingly, an information processing device that searches for an appropriate sentence in accordance with a current position or a situation of a user and presents the sentence to the user has been proposed (see PTL 1).

### CITATION LIST

### Patent Literature

[PTL 1]

JP 2011-232871 A

### SUMMARY

### Technical Problem

In recent years, with the development of message functions, a message is composed not only using so-called normal characters such as kanji, hiragana, katakana, and numerals but also special characters, pictorial characters, emoticons, and the like. Users can use the special characters, pictorial characters, emoticons, and the like to express various emotions in messages. Special characters, pictorial characters, emoticons, and the like in a message are mainly added to the end of a body of the message, and such usage is commonplace at present.

The technology described in PTL 1 merely presents users with sentences formed from normal characters, and the sentences formed from normal characters are insufficient for expressing various emotional expressions or intentions of messages of the users.

The present technology has been devised in view of such circumstances and an objective of the present technology is to provide an information processing device, an information processing method, and an information processing program capable of presenting users with optimum candidates of end portions added to the ends of bodies of messages.

### Solution to Problem

To solve the above-described problem, according to a first technology, an information processing device includes an end portion candidate determination unit configured to determine a plurality of candidates for an end portion that is added to an end of a body and forms a message along with the body.

According to a second technology, an information processing method includes determining a plurality of candidates for an end portion that is added to an end of a body and forms a message along with the body.

Further, according to a third technology, an information processing program causes a computer to execute an information processing method including determining a plurality of candidates for an end portion that is added to an end of a body and forms a message along with the body.

### BRIEF DESCRIPTION OF DRAWINGS

FIG. 1 is a block diagram illustrating a configuration of a terminal device 100.

FIG. 2 is a block diagram illustrating a configuration of an information processing device 200.

FIG. 3 is a diagram illustrating pictorial characters and emoticons.

FIG. 4 is a diagram illustrating bodies and end portions of messages.

FIG. 5 is a diagram illustrating other examples of end portions.

FIG. 6 is a flowchart illustrating a basic process.

FIG. 7 is a diagram illustrating user interfaces displayed on a display unit 105.

FIG. 8 is a flowchart illustrating a body candidate determination process.

FIG. 9 is a diagram illustrating a body database.

FIG. 10 is a diagram illustrating a first method of determining candidates for an end portion.

FIG. 11 is a flowchart illustrating a process of acquiring a usage count of an end portion.

FIG. 12 is a flowchart illustrating a process for details of dividing a body and an end portion of a sent message.

FIG. 13 is a diagram illustrating a second method of determining candidates for an end portion.

FIG. 14 is a diagram illustrating the second method of determining candidates for an end portion.

FIG. 15 is a diagram illustrating a third method of determining candidates for an end portion.

FIG. 16 is a diagram illustrating the third method of determining candidates for an end portion.

FIG. 17 is a diagram illustrating a fourth method of determining candidates for an end portion.

FIG. 18 is a diagram illustrating matching of a circumflex model and pictorial characters.

FIG. 19 is a flowchart illustrating a process in a terminal device of a sending/receiving partner.

FIG. 20 is a flowchart illustrating an arousal calculation process.

FIG. 21 is a flowchart illustrating a pleasure or displeasure calculation process.

FIG. 22 is a flowchart illustrating a matching process of pictorial characters and a circumflex model based on state information.

FIG. 23 is a diagram illustrating matching of an end expression and a circumflex model.

FIG. 24 is a flowchart illustrating a sixth method of determining candidates for an end portion.

FIG. 25 is a block diagram illustrating a configuration of a terminal device 300 in a seventh method of determining candidates for an end portion.

FIG. 26 is a diagram illustrating the seventh method of determining candidates for an end portion.

FIG. 27 is a diagram illustrating a user interface in the seventh method of determining candidates for an end portion.

FIG. 28 is a block diagram illustrating a configuration of an information processing device 400 according to an eighth method.

FIG. 29 is a diagram illustrating a user interface in the eighth method.

FIG. 30 is a diagram illustrating localization of end portions according to nation.

### DESCRIPTION OF EMBODIMENTS

Hereinafter, an embodiment of the present technology will be described with reference to the drawings. The description will be made in the following order.
<1. Embodiment>
[1-1. Configuration of terminal device 100]
[1-2. Configuration of information processing device 200]
[1-3. Body and end portion]
[1-4. Process in information processing device]
[1-4-1. Basic process and user interface]
[1-4-2. Body candidate determination process]
[1-5. Method of determining candidates for end portion]
[1-5-1. First method of determining candidates for end portion]
[1-5-2. Second method of determining candidates for end portion]
[1-5-3. Third method of determining candidates for end portion]
[1-5-4. Fourth method of determining candidates for end portion]
[1-5-5. Fifth method of determining candidates for end portion]
[1-5-6. Sixth method of determining candidates for end portion]
[1-5-7. Seventh method of determining candidates for end portion]
[1-5-8. Eighth method of determining candidates for end portion]
<2. Modification examples>

### 1. Embodiment

### [1-1. Configuration of Terminal Device 100]

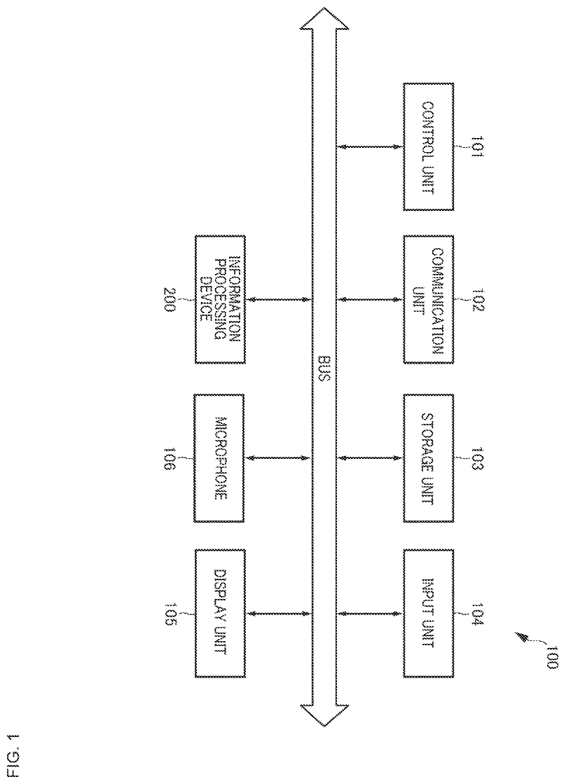

First, a configuration of a terminal device 100 in which an information processing device 200 operates will be described with reference to FIG. 1. The terminal device 100 includes a control unit 101, a storage unit 102, a communication unit 103, an input unit 104, a display unit 105, a microphone 106, and the information processing device 200.

The control unit 101 is configured by a central processing unit (CPU), a random access memory (RAM), and a read-only memory (ROM). The ROM stores a program or the like read and operated by the CPU. The RAM is used as a working memory for the CPU. The CPU performs various processes in accordance with programs stored in the ROM and controls the terminal device 100 by issuing commands.

The storage unit 102 is, for example, a storage medium configured by a hard disc drive (HDD), a semiconductor memory, a solid-state drive (SSD), or the like and stores a program, content data, and the like.

The communication unit 103 is a module that communicates with an external device or the like via the Internet in conformity with a predetermined communication standard. As a communication method, there is a wireless local area network (LAN) such as wireless fidelity (Wi-Fi), a 4th generation mobile communication system (4G), broadband, Bluetooth (registered trademark), or the like. An outgoing message generated by the information processing device 200 is sent to a device of a partner in exchange of messages (hereinafter referred to as a sending/receiving partner) through communication of the communication unit 103.

The input unit 104 is any of various input devices used for a user to perform an input on the terminal device 100. As the input unit 104, there is a button, a touch panel integrated with the display unit 105, or the like. When an input is performed on the input unit 104, a control signal is generated in response to the input and is output to the control unit 101. Then, the control unit 101 performs control or a calculation process corresponding to the control signal.

The display unit 105 is a display device or the like that displays content data such as an image or a video, a message, a user interface of the terminal device 100, and the like. The display device is configured by, for example, a liquid crystal display (LCD), a plasma display panel (PDP), an organic electro-luminescence (EL) panel, or the like.

In description of the present technology, the display unit 105 is assumed to be a touch panel integrated with the input unit 104. On the touch panel, a touching operation performed with a finger or a stylus on a screen which is an operation surface and a display surface of the display unit 105 can be detected and information indicating a touch position can be output. The touch panel can detect each operation repeated on the operation surface and output information indicating a touch position of each operation. Here, the expression “touch panel” is used as a generic name for a display device which can be operated by touching the display unit 105 with a finger or the like.

Thus, the touch panel can receive and detect various inputs and operations such as a so-called tapping operation, a double tapping operation, a touching operation, a swiping operation, and a flicking operation from the user.

The tapping operation is an input operation of the user touching an operation surface only once with a finger or the like and removing it in a short time. The double tapping operation is an input operation of touching the operation surface with a finger or the like and removing it twice in succession at a short interval. These operations are mainly used to input a determination or the like. The tapping operation is an input method including operations from an operation of touching the operation surface with a finger or the like to an operation of removing the finger. A long pressing operation is an input operation of the user touching the operation surface with a finger or the like and maintaining the touch state for a predetermined time. A touching operation is an input operation of the user touching the operation surface with a finger or the like. A difference between the tapping operation and the touching operation is whether an operation of removing the finger that has touched the operation surface is included. The tapping operation is an input method that includes a removing operation and the touching operation is an input operation that does not include a removing operation.

The swiping operation is also called a tracing operation and is an input operation of the user moving a finger or the like with the finger touching the operation surface. The flicking operation is an input operation of the user pointing at one point on the operation surface with a finger or the like and then flicking fast in any direction from that state.

The microphone 106 is a voice input device used for the user to input a voice.

The information processing device 200 is a processing unit configured by the terminal device 100 executing a program. The program may be installed in advance in the terminal device 100 or may be downloaded or distributed to a storage medium or the like to be installed by the user by herself or himself. The information processing device 200 may be realized by a program and may also be realized in combination with a dedicated hardware device or a circuit that has that function. The information processing device 200 is equivalent to the information processing device 200 in claims.

The terminal device 100 is configured in such manners. In the following description, the terminal device 100 is assumed to be a wristwatch type wearable device. The present technology is useful for the terminal device 100 such as a wristwatch type wearable device that has a size which is not as large as the size of a display screen and the size of a touch panel and on which it is not easy to compose and check a sent message.

### [1-2. Configuration of Information Processing Device 200]

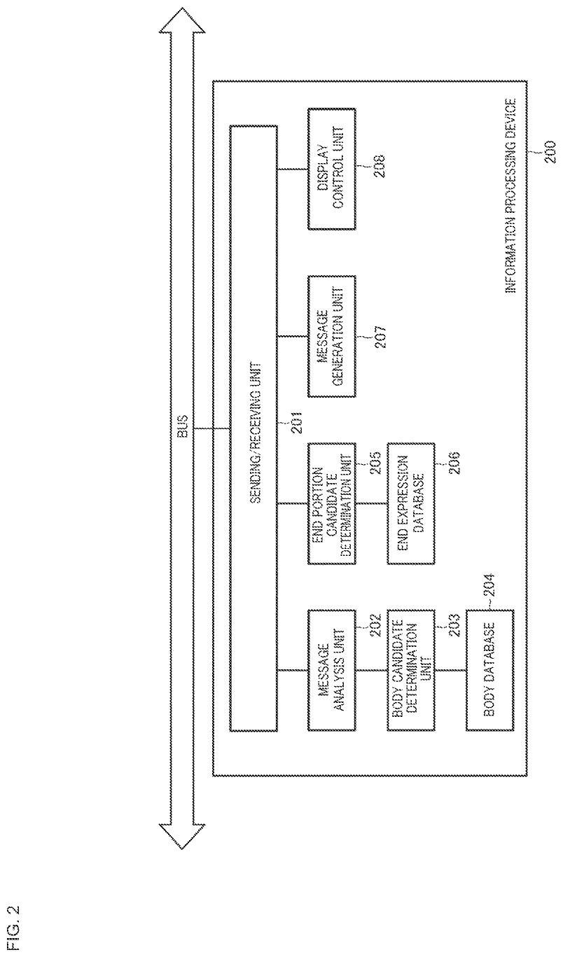

Next, a configuration of the information processing device 200 will be described with reference to FIG. 2. The information processing device 200 includes a sending/receiving unit 201, a message analysis unit 202, a body candidate determination unit 203, a body database 204, an end portion candidate determination unit 205, an end expression database 206, a message generation unit 207, and a display control unit 208.

The sending/receiving unit 201 supplies a message received by the terminal device 100 from a sending/receiving partner to each unit of the information processing device 200 and supplies an outgoing message generated by the information processing device 200 to the terminal device 100. Inside the information processing device 200, a body, an end portion, and the like are exchanged.

The message analysis unit 202 analyzes a received message received by the terminal device 100 and the body candidate determination unit 203 extracts a feature for determining candidates for a body.

The body candidate determination unit 203 determines a plurality of candidates for a body to be presented to a user from the body database 204 based on the feature of the received message extracted by the message analysis unit 202.

The body database 204 is a database that stores the plurality of candidates for a body that forms an outgoing message to be sent by the user in response to the received message.

The end portion candidate determination unit 205 determines a plurality of candidates for an end portion to be presented to the user from a plurality of end expressions stored in the end expression database 206. The end portion is added to an end of the body and is a part of a message that forms the outgoing message.

The end expression database 206 is a database that stores a plurality of end expressions which are candidates for the end portion that forms the outgoing message to be sent by the user in response to the received message. Of many end expressions stored in the end expression database 206, several end expressions are displayed as the candidates for the end portion on the display unit 105 and are presented to the user. The end expression is a character string formed by special characters or the like added to the end of the body as the end portion of the outgoing message.

The message generation unit 207 generates the outgoing message to be sent by the user by combining the body and the end portion selected by the user.

The display control unit 208 displays the candidates for the body and the candidates for the end portion on the display unit 105 of the terminal device 100, and further a user interface or the like for generating and sending the outgoing message.

The terminal device 100 and the information processing device 200 are configured in this way.

### [1-3. Body and End Portion]

Next, the body and the end portion that form the outgoing message will be described. The outgoing message is formed by only the body or a combination of the body and the end portion. The body is a sentence configured by characters such as hiragana, katakana, kanji, or alphanumeric characters (referred to as ordinary characters). The end portion includes special characters, pictorial characters, and all kinds of characters other than ordinary characters used in a body, is added to the end of the body, and forms an outgoing message.

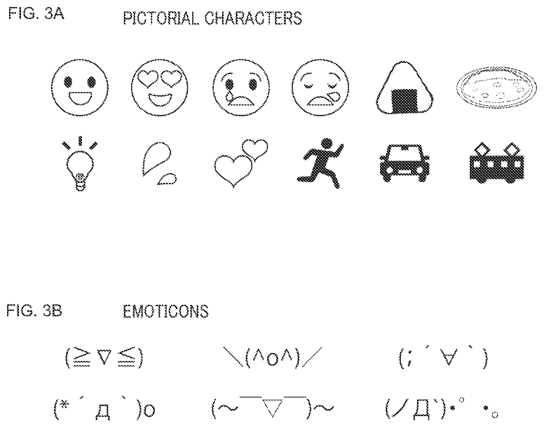

The pictorial characters are characters displayed as one picture in a display region equivalent to one character (for example, an icon or a glyph of a human face, an automobile, food, or the like), as illustrated in FIG. 3A.

The special characters include characters such as symbolic characters such as ?, !, +, −, ±, ×, &, #, $, %, an arrow and characters indicating a figure such as a triangle, a heart, or a star, other than ordinary characters such as hiragana, katakana, kanji, or alphanumeric characters.

Apart from the pictorial characters and the special characters, characters that form an end portion also include so-called emoticons. As illustrated in FIG. 3B, emoticons represent a human face or action or a character's face or action by combining a plurality of numbers, hiragana, katakana, foreign language characters, special characters, symbols, and the like.

To facilitate description, special characters, pictorial characters, and emoticons are collectively referred to as “special characters or the like” in the following description.

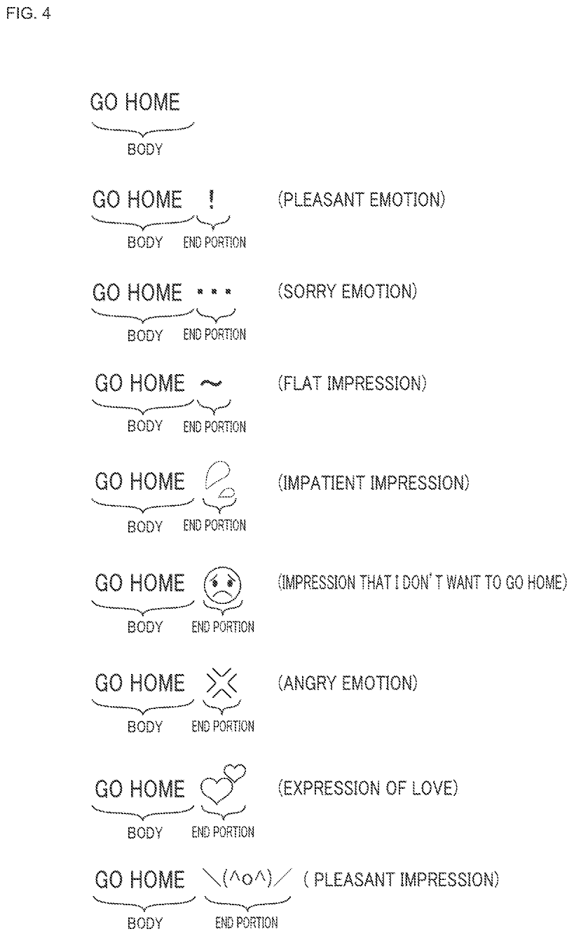

A user can convey various emotions, impressions, or expressions which cannot be conveyed with only a body illustrated in FIG. 4 by adding any of various end expressions as an end portion to the end of the body to a message sending/receiving partner. As illustrated in FIG. 4, the message can express different impressions, emotions, or expressions overall when an end portion is different even in a sentence with the same body. The emotions, impressions, and expressions in the end portions illustrated in FIG. 4 are merely exemplary.

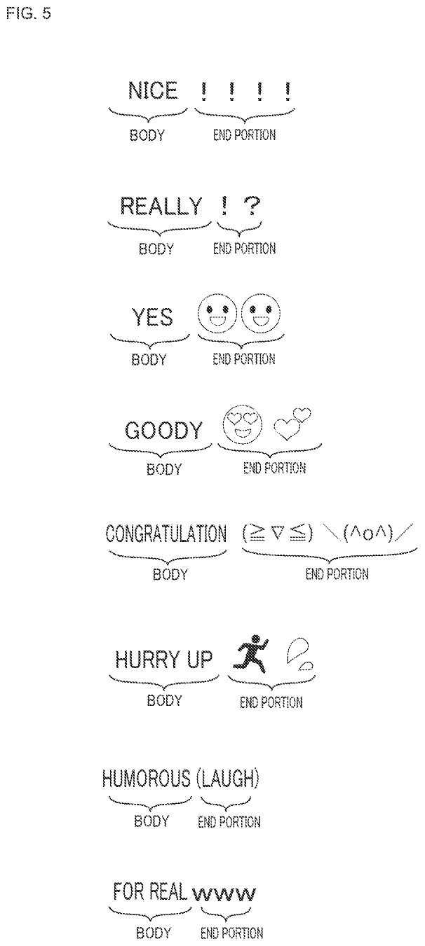

The number of special characters that form the end portion added to the end of the body is not limited to 1. As illustrated in FIG. 5, the end portion is also configured using a plurality of special characters, pictorial characters, and emoticons. The end portion is also configured including (or consisting solely of) a kanji or an alphabetic character such as the one meaning “(Laugh)” or “www” illustrated in FIG. 5.

The end expression database 206 stores end expressions formed by various kinds of special characters or the like illustrated in FIG. 3 and also stores end expressions configured by a combination of a plurality of special characters or the like illustrated in FIG. 5 and end expressions configured by characters other than special characters or the like. The end expression database 206 may store end expressions formed from all of special characters and pictorial characters which can be used in the terminal device 100 in advance. The end expression database 206 may also store end expressions configured by a combination of a plurality of special characters or the like based on information on the Internet or a use history of a user in advance. Further, the end expression database 206 may be connected to a server on the Internet and can be updated periodically or at any timing. Since use of language varies over time, the end expression database 206 is configured to be able to be updated to cope with use of latest end expressions.

### [1-4. Process in Information Processing Device 200]

### [1-4-1. Basic Process and User Interface]

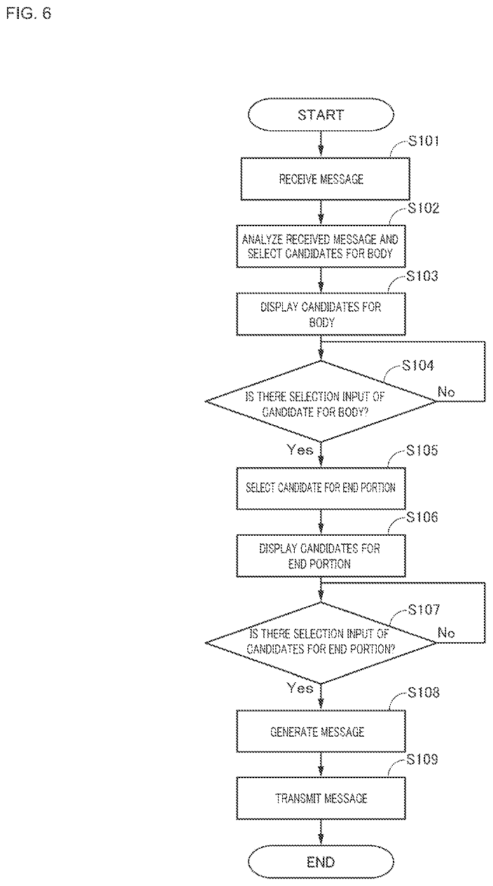

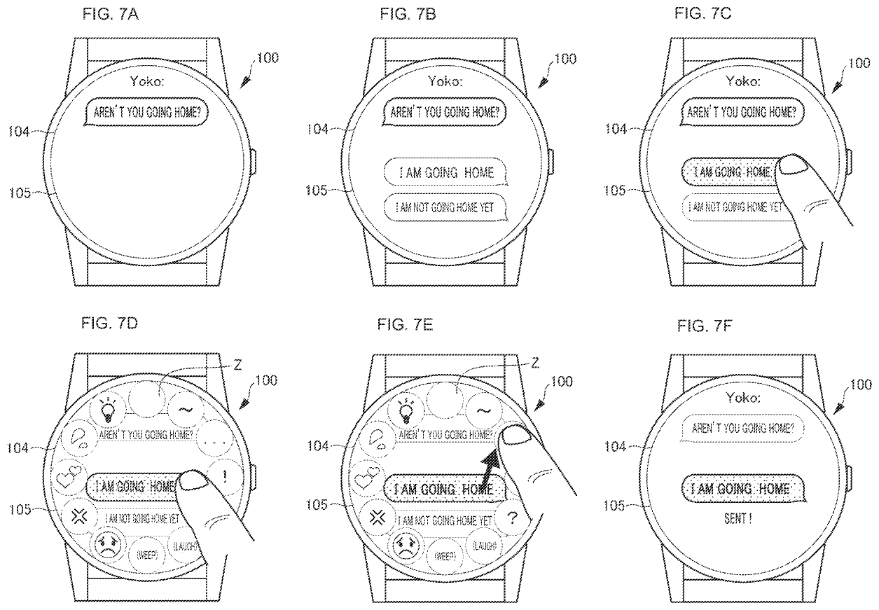

Next, a configuration of a user interface displayed on the display unit 105 of the terminal device 100 for the information processing device 200 to perform a basic process and to compose an outgoing message will be described with reference to the flowchart of FIG. 6 and FIG. 7.

First, in step S101, a message is received from the sending/receiving partner. As illustrated in FIG. 7A, the received message is displayed on the display unit 105 of the terminal device 100 and is supplied to the message analysis unit 202.

Subsequently, in step S102, the message analysis unit 202 analyzes the received message and the body candidate determination unit 203 determines two optional candidates of a body to be presented to the user from the body database 204. When there is no candidate for the body to be presented to the user in the body database 204, it may be determined that there is no candidate for the body. The details of the analysis of the received message and the body candidate determination process will be described below.

Subsequently, in step S103, the display control unit 208 displays the determined candidates for the body on the display unit 105. As illustrated in FIG. 7B, the candidates for the body are displayed in parallel on the display unit 105 of the terminal device 100. Thus, two options for candidates for the body of the outgoing message can be presented to the user. In the example of FIG. 7B, for a received message “Aren't you going home?” two options for candidates “I am going home” and “I am not going home” for the body are displayed. When the candidates for the body are displayed on the display unit 105, the received message may be displayed together or the received message may not be displayed. Here, when the received message is displayed, the user can select a candidate for the body and select a candidate for the end portion while checking the received message.

Subsequently, when the user selects one of the candidates for the body in step S104, the process proceeds to step S105 (Yes in step S104). The user performs a selection input by performing a touch operation on the display unit 105 configured as a touch panel, as illustrated in FIG. 7C. The selected candidate for the body may be changed so that it is easy to recognize selection of a display aspect.

Subsequently, in step S105, the end portion candidate determination unit 205 determines candidates for the end portion to be presented to the user among a plurality of end expressions of the end expression database 206. A method of determining the candidates for the end portion will be described later.

Subsequently, in step S106, the display control unit 208 displays the determined candidates for the end portion on the display unit 105. As illustrated in FIG. 7D, the candidates for the end portion are displayed as icons in a circular shape substantially centering on the selected candidate for the body, as illustrated in FIG. 7D. In disposition of the icons in the circular state, the icons are disposed along the shape of the display unit 105.

Subsequently, when the user selects one of the candidates for the end portions in step S107, the process proceeds to step S108 (Yes in step S107). In the selection input of a candidate for the end portion, when the user touches a display surface of the display unit 105 with a finger with which the selection input of the candidate for the body is performed, as illustrated in FIG. 7C, the candidates for the end portion are displayed, as illustrated in FIG. 7D, and subsequently the user moves up to a selected icon of the candidate for the end portion and removes (swipes) the finger from the display surface on an icon of the candidate of the end portion selected by the user, as illustrated in FIG. 7E, the end portion corresponding to the icon is selected.

According to this input method, since the selection of the candidate for the body and the selection of the candidate for the end portion can be performed through a single touch of the finger on the display surface of the display unit 105, the user can perform selection intuitively, easily, and quickly. When the candidate for the body is selected and subsequently the finger is removed from the display surface in a region other than the icon of the end portion on the display unit 105 during the selection of the candidate for the end portion, the display surface may return to a selection screen for selection of a candidate for the body illustrated in FIG. 7B. In this way, the user can select a candidate for the body again.

An input method is not limited to a method of performing a single touch on the display surface of the display unit 105 with a finger. After a tapping operation is performed on a candidate for the body (that is, a finger is temporarily removed from the display surface of the display unit 105), a tapping operation may be performed again to select a candidate for the end portion.

As illustrated in FIGS. 7D and 7E, an icon Z disposed at a top position is an icon for sending an outgoing message with no end portion among icons indicating the candidates for the end portion disposed in the circular state on the display unit 105. The user may also want to send the outgoing message with only a body to which an end portion is not added. By displaying the icon Z for selecting a candidate to which an end portion is not added in a similar display aspect to an icon for selecting a candidate to which an end portion is added, it is possible to compose an outgoing message to which an end portion is not added through a similar operation to a case in which an end portion is added. Thus, consistency is maintained between a case in which an end portion is added and a case in which an end portion is not added, and thus the user can compose an outgoing message intuitively. When a finger or the like is removed from the display surface of the display unit 105 after the selection input of a candidate for the body without displaying the icon Z, only a body to which the end portion is not added may form an outgoing message.

Until the user selects one of the candidates for the end portion in step S107, the selection input by the user is awaited (No in step S107).

Subsequently, in step S108, the message generation unit 207 generates the outgoing message. The outgoing message is generated by combining the candidate for the end portion selected by the user with the candidate for the end portion of the body selected by the user. In step S109, the communication unit 103 of the terminal device 100 sends the outgoing message to the terminal device of the sending/receiving partner. As illustrated in FIG. 7F, when the outgoing message is sent, the sent message and a notification indicating that the message is sent are displayed on the display unit 105.

Before the outgoing message is composed and then the outgoing message is sent, a step of checking whether to display the outgoing message on the display unit 105 and send the message may be provided. Thus, it is possible to prevent a message with inappropriate content from being erroneously sent.

The information processing device 200 performs the basic process, as described above, in such a manner that the candidate for the body is determined and presented, the candidate for the end portion is determined and presented, the selection by the user is received, and the outgoing message is sent.

### [1-4-2. Body Candidate Determination Process]

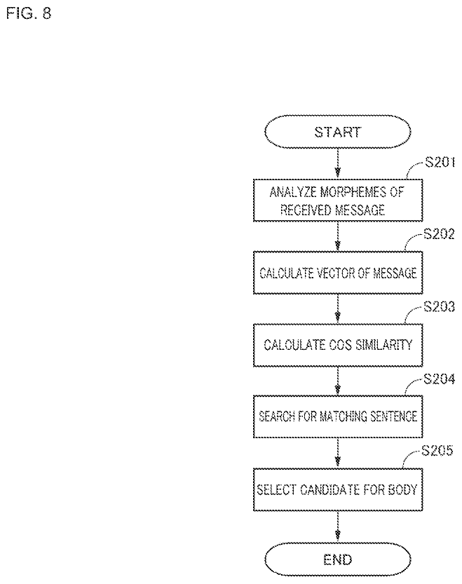

Next, the details of the analysis of the received message and the body candidate determination process in step S102 of the flowchart of FIG. 6 will be described with reference to the flowchart of FIG. 8.

First, in step S201, the message analysis unit 202 analyzes morphemes of the received message. Subsequently, in step S202, for each word, term frequency (TF)-inverse document frequency (IDF) is calculated and a vector of the received message is calculated. TF-IDF is one scheme for evaluating the importance of a word included in a sentence, wherein TF indicates an appearance frequency of the word and IDF indicates an inverse document frequency.

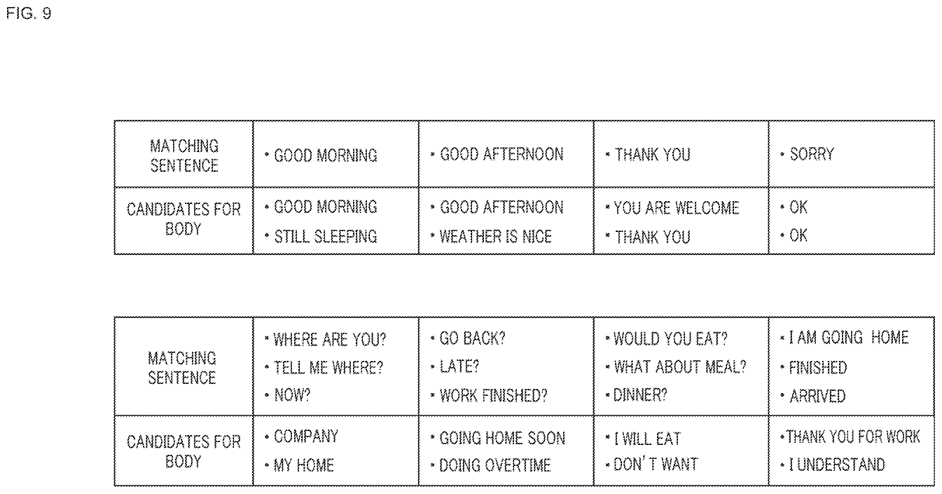

Subsequently, in step S203, COS similarity with a matching sentence in the body database 204 is calculated. The COS similarity is an index of similarity calculation used to compare documents or vectors in a vector space model. The body database 204 stores a matching sentence corresponding to a message sent from the sending/receiving partner and received by the user in advance in association with candidates (two options for candidates in the embodiment) for the body which are responses to the matching sentence, as illustrated in FIG. 9. For efficiency of a process, the matching sentence of the body database 204 may be built as a database by calculating TF-IDF in advance.

Subsequently, in step S204, a matching sentence with the closest COS similarity to the received message is searched for from a dialogue database. In step S205, candidates for the body in the body database 204 associated with the matching sentence with the closest COS similarity are determined as two options for candidates for the body to be presented to the user.

In this way, the candidates for the body are determined. The body candidate determination method is exemplary. A body candidate determination method is not limited to this method and another method may be used.

### [1-5. Method of Determining Candidates for End Portion]

### [1-5-1. First Method of Determining Candidates for End Portion]

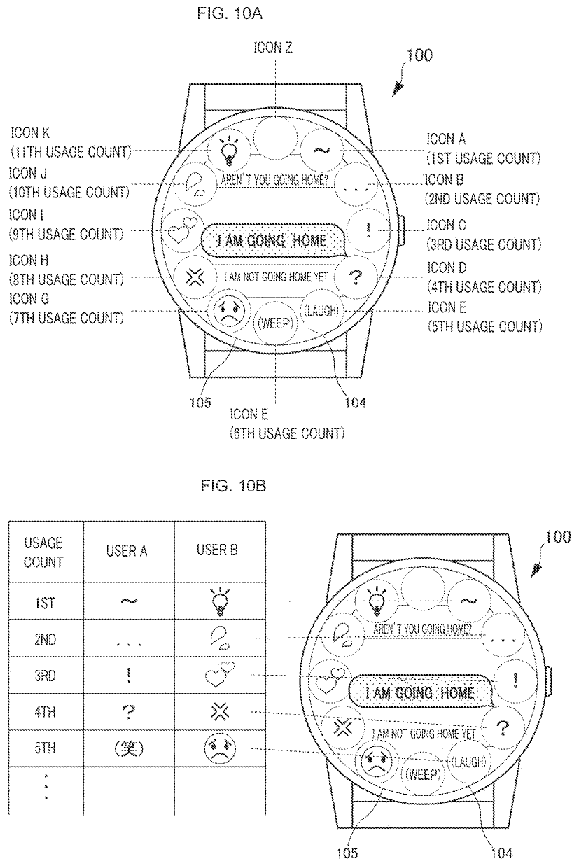

Next, a first method of determining candidates for an end portion will be described. The first method is a method based on a usage count of an end portion by the user (which may be a usage rate), as illustrated in FIG. 10A. In the example of FIG. 10A, icons from an icon A to an icon K are disposed clockwise on the display unit 105 in order from end expressions which are the candidates for the end portion of which a usage count is higher. The icon A indicates an end expression with the highest usage count at that time as a candidate for the end portion, the icon B indicates an end expression with the 2nd highest usage count as a candidate for the end portion, and the icon C indicates an end expression with the 3rd highest usage count as a candidate for the end portion. In this way, the icons continue to the icon K. The icon Z displayed at the top position is an icon for selecting to forgo adding an end portion to the body, as described above.

By disposing the candidates for the end portion in the order from the highest usage count in this way, it is possible to compose the outgoing message easily and quickly using the frequently used end expressions. The icons indicating the candidates for the end portion in FIG. 10A are disposed clockwise in order from the highest usage count, but the present technology is not limited thereto. The icons may be disposed counterclockwise.

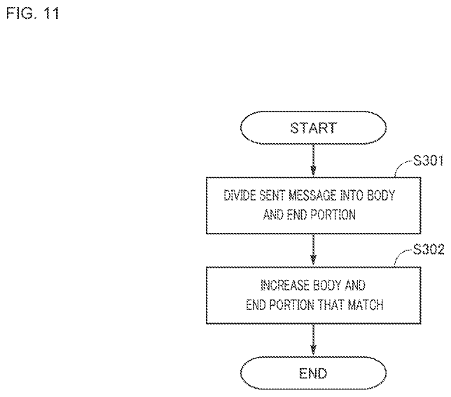

Here, a process of acquiring the usage count of the end portion will be described with reference to the flowchart of FIG. 11A. The process of acquiring the usage count is performed for each individual sent message sent from the terminal device 100.

First, in step S301, a sent message which is a processing target is divided into a body and an end portion. Subsequently, in step S302, when the body and the end portion of the sent message are compared and match a body and end portion in the end expression database 206 in a usage count database of FIG. 11B, the usage count increases. The usage count of the end portion can be updated. Therefore, when this process is performed periodically or each time a message is sent, the latest usage count of the end portion can always be acquired. The usage count database may be included in the end expression database 206 or may be configured to be separately independent.

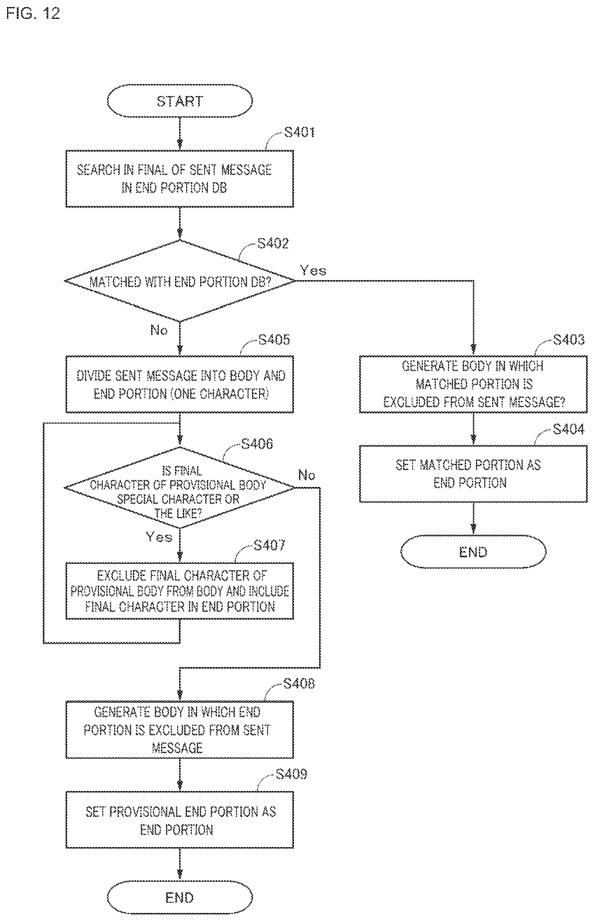

Here, the details of the division of the body and the end portion of the sent message in step S301 of the flowchart of FIG. 11 will be described with reference to the flowchart of FIG. 12.

First, in step S401, it is determined whether the end of the sent message matches one of a plurality of end expressions in the end expression database 206. The end of the sent message in this case is not limited to one character, but can be two or more characters in some cases. When the end of the sent message matches one of the plurality of end expressions, the process proceeds from step 402 to 403 (Yes in step 402).

Subsequently, in step 403, a portion in which a portion matching the end expression of the sent message in the end expression database 206 is excluded is set as a body. Subsequently, in step 404, a portion in which a portion matches the end expression of the sent message in the end expression database 206 is set as an end portion. Thus, the sent message can be divided into the body and the end portion. Steps S403 and S404 may be performed in reverse order or may be performed simultaneously as a process.

Conversely, when the end of the sent message does not match any of the end expressions in the end expression database 206 in step S401, the process proceeds from step S402 to step S405 (No in step S402).

Subsequently, in step S405, the final character of the sent message is divided as a provisional end portion and the other characters are divided as a provisional body. This is not the finally divided body and end portion but is a provisional division. Subsequently, in step S406, it is determined whether the final character of the provisional body is a special character or the like.

When the final character is a special character or the like of the provisional body, the process proceeds to step S407 (Yes in step S406). Then, the special character or the like which is the final character of the provisional body is excluded from the provisional body and is included in the provisional end portion. The process returns to step S406 and it is determined again whether the final character of the provisional body is a special character or the like. Accordingly, steps S406 and S407 are repeated until the final character of the provisional body is not a special character or the like.

Through this process, even when the end portion of the sent message is configured of a plurality of continuous special characters or the like not included in the end expression database 206, the plurality of continuous special characters or the like can be divided as an end portion from a body.

When the final character of the provisional body is not a special character or the like, the process proceeds to step S408 (No in step S406). Then, the provisional body of the sent message is set as a body in step 408 and the provisional end portion of the sent message is set as an end portion in step 409. Thus, the sent message can be divided into the body and the end portion. Steps S408 and S409 may be performed in reverse order or may be performed simultaneously as a process.

According to the first method, the candidates for the end portion are determined based on the usage count of the end portions of the user. Therefore, the end portions frequently used by the user can be presented as candidates and the user can compose the outgoing message quickly and easily.

The usage count of the end portion may be a usage count of an individual user of the terminal device 100 or may be a sum of usage counts of a plurality of users. The present technology is not limited to only the terminal device 100. A sum of usage counts in a wearable device, a smartphone, a tablet terminal, a personal computer, and the like which are owned by the user and used to send and receive messages may be used. The same goes for a case in which the number of users is plural. The present technology is not limited to an outgoing message and a usage count of an end portion posted in various social network services (SNSs) may be used. As illustrated in FIG. 10B, the order of the usage count may be different for each user. This is effective when one terminal device 100 is used by a plurality of people.

When a message composed using the present technology is included in the usage count of the end portion, there is concern of a measurement result of the usage count being biased. Accordingly, when the usage counts of the end portions in the message sent in a plurality of devices are summed, weighting may be performed for each device. For example, a message sent by a device that has a function of the information processing device 200 according to the present technology may be weighted low. Thus, it is possible to prevent a measurement result of the usage count from being biased. For example, a message composed according to the present technology may not be included in the measurement of the usage count.

### [1-5-2. Second Method of Determining Candidates for End Portion]

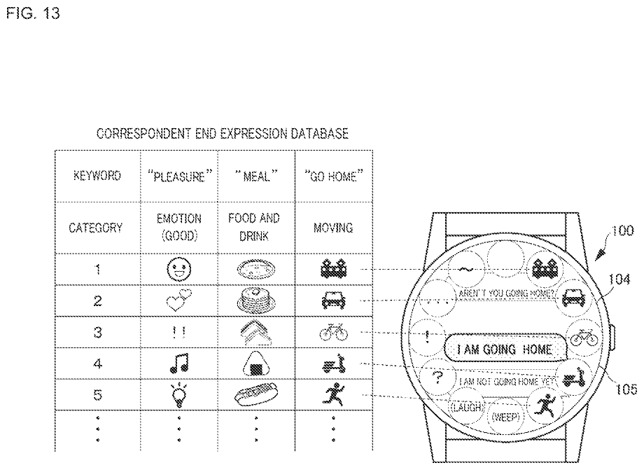

Next, a second method of determining candidates for an end portion will be described. A second method is a method of presenting an end expression that has a matching relation with a keyword included in a body that forms a message as the candidates for the end portion, as illustrated in FIG. 13.

For example, as illustrated in FIG. 13, a correspondent end expression database (which may be included in the end expression database 206) is built by causing keywords such as “Pleasure,” “Meal,” and “Go home” to correspond to end expressions related to the keywords in advance. In the example of FIG. 13, end expressions formed by pictorial characters such as a train, a car, a bicycle, and run implying going back are associated with the keyword “Go home”. End expressions formed by pictorial characters such as dishes, ramen, beer, and a rice ball implying eating are associated with the keyword “Meal.” Further, end expressions formed by pictorial characters such as a smiling face and a heart mark implying a pleasant emotion are associated with the keyword “Pleasure.” The correspondent end expression database may be built in advance and updated periodically in accordance with a usage count of an end portion of the user.

An icon indicating an end expression that has a matching relation with a keyword included in a body that forms the sent message is displayed and presented as a candidate for the end portion on the display unit 105. In the example of FIG. 13, since the keyword “Go home” is included in the body of the sent message is “I am going home,” end expressions corresponding to the keyword “Go home” are displayed and presented as candidates for the end portion on the display unit 105.

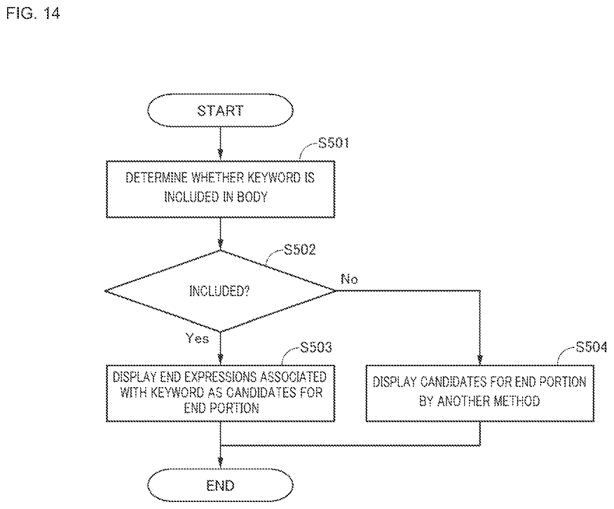

Next, a process for realizing a second method will be described with reference to the flowchart of FIG. 14.

First, in step S501, it is determined whether a keyword is included in a body selected by the user. Whether the keyword is included in the body can be determined by comparing the body with the correspondent end expression database in which a plurality of keywords are stored. When the keyword is included in the body, the process proceeds from step S502 to step S503 (Yes in step S502).

In step S503, a plurality of end expressions associated with the keyword are displayed and presented with icons as candidates for the end portion on the display unit 105. The display with the icons is exemplary and the display of the candidates for the end portion is not limited to the icons.

Conversely, when the keyword is not included in the body, the process proceeds from step S502 to step S504 (No in step S502). In step S504, other than the end portion associated with the keyword, as another method, for example, the end expressions may be displayed and presented as the candidates for the end portion on the display unit 105 using a standard template.

According to the second method, it is possible to present the candidates for the end portion that has the matching relation with the keyword in the body of the sent message to the user.

### [1-5-3. Third Method of Determining Candidates for End Portion]

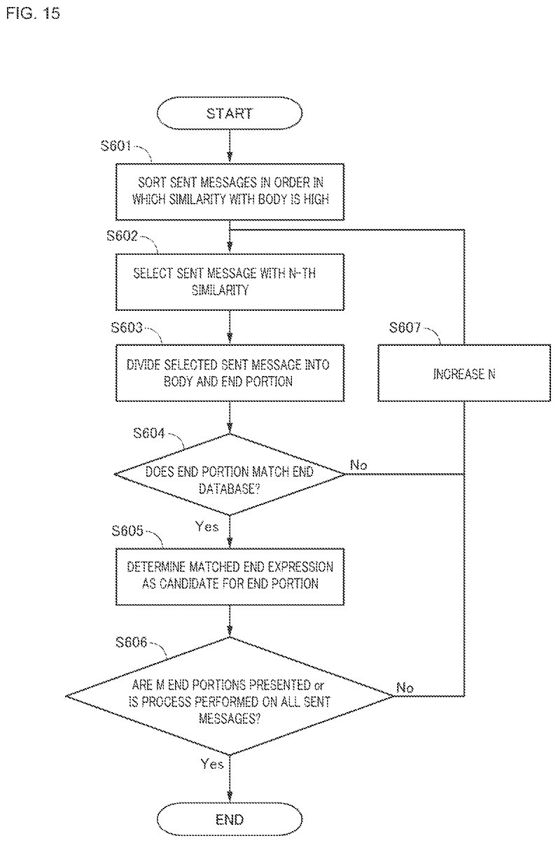

Next, a third method will be described as a method of determining candidates for an end portion. The third method is a method of determining candidates for an end portion based on similarity between the body and a past sent message. A process for realizing the third method will be described with reference to the flowchart of FIG. 15.

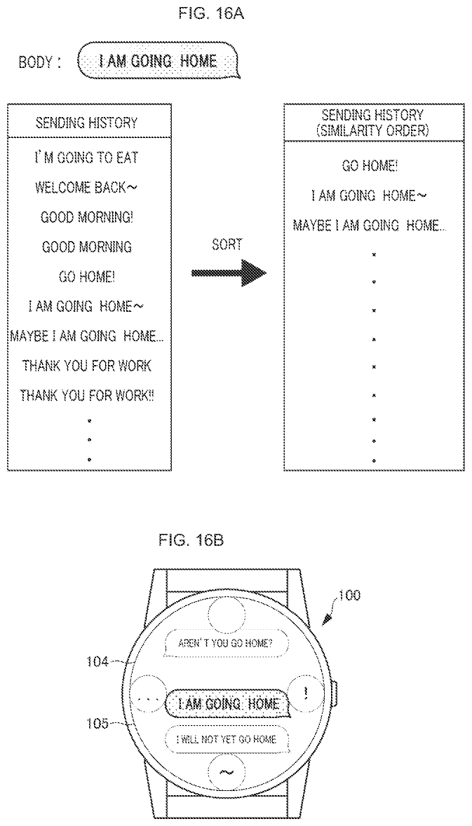

First, in step S601, as illustrated in FIG. 16, a plurality of sent messages in a past sending history are sorted in the order in which the similarity with the body is high. In FIG. 16A, a body selected by the user from two candidates for the body is assumed to be “Go home” and similarity with the body is assumed to be calculated with COS similarity of TF-IDF. Since a function of retaining a past sending history is a function normally included in various message functions of the terminal device 100, the process may be performed with reference to the retained sending history.

Subsequently, in step S602, a sent message with N-th high similarity is selected. An initial value of N is 1. Accordingly, the sent message with the highest similarity is first selected. Subsequently, the sent message selected in step S603 is divided into a body and an end portion. As a scheme of dividing the sent message into the body and the end portion, the above-described scheme described with reference to FIG. 12 can be used.

Subsequently, in step S604, it is determined whether the divided end portion matches one of the plurality of end expressions in the end expression database 206. When the divided end portion matches the end expression, the process proceeds from step S604 to step S605 (Yes in step S604). In step S605, the end expression matched in step S604 is determined as a candidate for the end portion.

Subsequently, in step S606, it is determined whether M (where M is a predetermined number of candidates for the end portion displayed and presented on the display unit 105) candidates for the end portion are determined or the process is performed on all the sent messages. When any is satisfied, the process ends (Yes in step S606). The reason why the process ends is that when M candidates for the end portion are determined, the candidates for the end portion displayed on the display unit 105 are all determined, and therefore it is not necessary to perform the more process. When the process is performed on all the sent messages, this is because that the more process cannot be performed although the number of candidates for the end portion does not reach the number of candidates for the end portion which can be displayed on the display unit 105.

When all is satisfied in step S606, the process proceeds to step S607 (No in step S606). In step S607, N increases and the process proceeds to step S602. N increases and thus the process is subsequently performed on the sent message with N=2, that is, second similarity. The process is repeated from step S602 to step 5606 until the condition of step S606 is satisfied. Even when the end portion does not match any of the end expressions of the end expression database 206 in step S604, the process proceeds to step S607 (No in step S604).

In the example of FIG. 16B, end portions of “Go home!,” “I am going home˜,” and “Maybe, I am going home . . . ” which are sent messages similar to the body “I am going home” are displayed and presented as candidates on the display unit 105.

According to the third method, since the candidates for the end portion used in past sent messages similar to the sent message are presented to the user, the user can easily compose the sending message to which the similar end portion to the past sent messages is added.

### [1-5-4. Fourth Method of Determining Candidates for End Portion]

Next, a fourth method of determining candidates for an end portion will be described. The fourth method is a method of determining the candidates for the end portion based on a relation between the user and a message sending/receiving partner.

For example, in the case of a relation in which the message sending/receiving partner is a family member or a friend of the user, end expressions formed by pictorial characters are displayed and presented as candidates for the end portion on the display unit 105. On the other hand, for example, in the case of a relation between the user and the message sending/receiving partner who is a boss of a workplace, end expressions formed from corresponding symbols are displayed and presented as candidates for the end portion on the display unit 105 other than the pictorial characters.

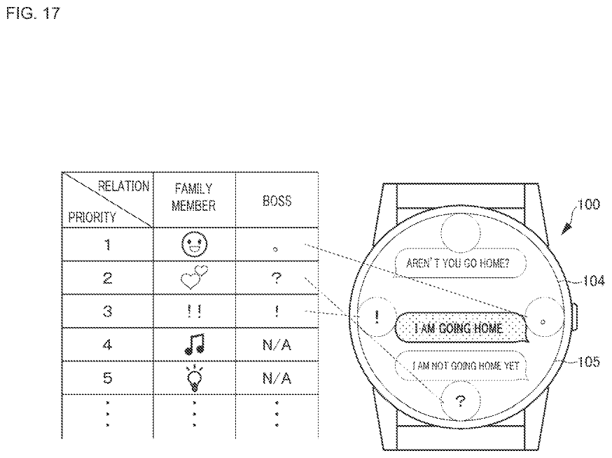

To realize this, as illustrated in FIG. 17, relations between the user and the sending/receiving partner in the end expression database 206 may be associated with end expressions in advance and only the end expressions corresponding to each relation may be displayed as candidates for the end portion on the display unit 105.

A relation between the user and a sending destination of the sending message can be determined with reference to address information, a sending/receiving history or the like of a message, or the like retained in the terminal device 100. The sending/receiving history of past messages can also be narrowed down to a destination to ascertain a relation with a sending partner.

According to the fourth method, for example, it is possible to prevent a message with pictorial characters from being erroneously sent to a boss to which a message with pictorial characters is generally not sent.

### [1-5-5. Fifth Method of Determining Candidates for End Portion]

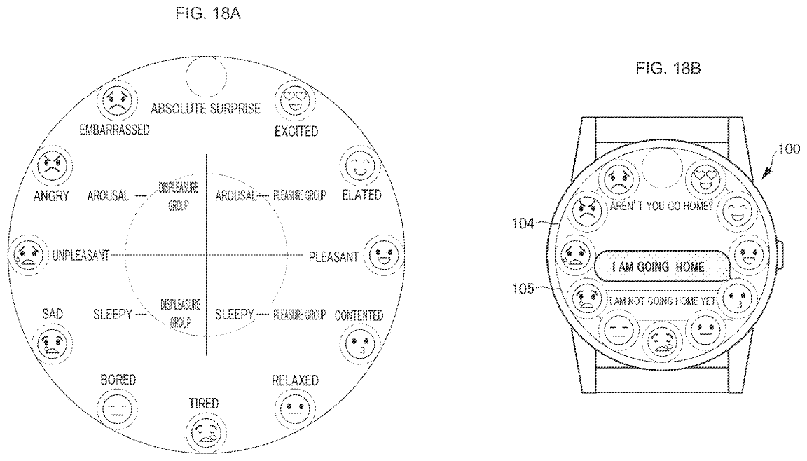

Next, a fifth method of determining candidates for an end portion will be described. The fifth method is a method of determining candidates for an end portion based on a circumflex model for emotions. As the circumflex model for emotions, for example, the circumflex model of Russell can be used. As illustrated in FIG. 18A, the circumflex model of Russell is used to ascertain correspondence of balances between pleasure and unpleasure, and arousal and relief of people with 2-dimensional axes. Pictorial characters (end expressions) associated with the circumflex model for emotions in FIG. 18A are examples in which emotions represented by pictorial characters correspond to arousal and relief, and pleasure and unpleasure of people in the circumflex model in advance. The end portion candidate determination unit 205 determines candidates for an end portion based on correspondent information of the end expressions and the circumflex model.

Then, based on the circumflex model of Russell, icons indicating the end expressions are displayed as the candidates for the end portion on the display unit 105 as in FIG. 18B. Since emotions related to emotions shown in the circumflex model of Russell are disposed nearby, the user can select the candidates for the end portion more intuitively and compose an outgoing message according to the fifth method. The display of the icons is exemplary and the display of the candidates for the end portion is not limited to the icons.

### [1-5-6. Sixth Method of Determining Candidates for End Portion]

Next, a sixth method of determining candidates for an end portion will be described. The sixth method is a method of determining candidates for an end portion based on a state of a sending/receiving partner acquired based on sensor information.

In the sixth method, the end portion candidate determination unit 205 determines the candidates for the end portion based on information indicating the state of the sending/receiving partner sent along with a message from the sending/receiving partner of the message for the user (hereinafter referred to as state information).

The state information can be acquired from the sensor information. To perform the sixth method, it is necessary to acquire sensor information indicating whether a terminal device of the sending/receiving partner includes at least a biological sensor such as a heart rate sensor, a perspiration sensor, a pulse wave sensor, a body temperature sensor, or a facial expression recognition sensor, from the biological sensor serving as an external device.

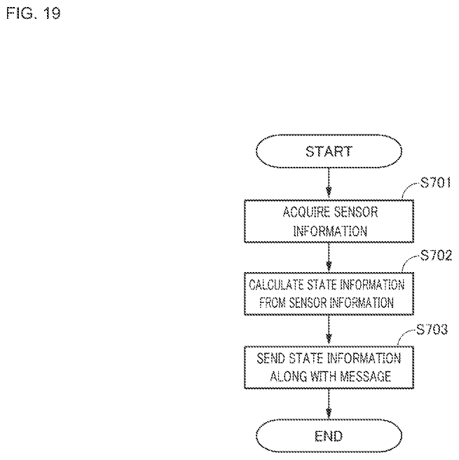

The flowchart of FIG. 19 is a flowchart illustrating a process in the terminal device of the sending/receiving partner. First, in step S701, sensor information of the sending/receiving partner is acquired. Subsequently, in step S702, information regarding the state of the sending/receiving partner is calculated from the sensor information. In step S703, the state information is sent to the terminal device 100 of the user along with a message.

As a method of acquiring the state information from the sensor information, there is a method based on a circumflex model for emotions. For example, the degree of arousal and relief can be obtained from an electrodermal reaction obtained by a perspiration sensor. In arousal, the fact that a resistant value is lowered due to generation of psychogenic perspiration is used. The degree of pleasure or displeasure can be obtained from a pulse wave (a fingertip volume pulse wave) obtained by a pulse wave sensor. The fact that a pulse wave amplitude value at the time of unpleasant stimulus is higher than that at the time of pleasant stimulus is used.

For example, arousal in which the electrodermal reaction is strong is indicated by combining sensing of a pulse wave and an electrodermal reaction. When a pleasure in which a pulse wave is weak is indicated, it can be analyzed that an emotion of “alert” or “excited” is indicated. There is a method of detecting arousal and relief by measuring a variation in a R-R sensation by electrocardiogram. Therefore, another combination method can also be used without being limited to the above methods.

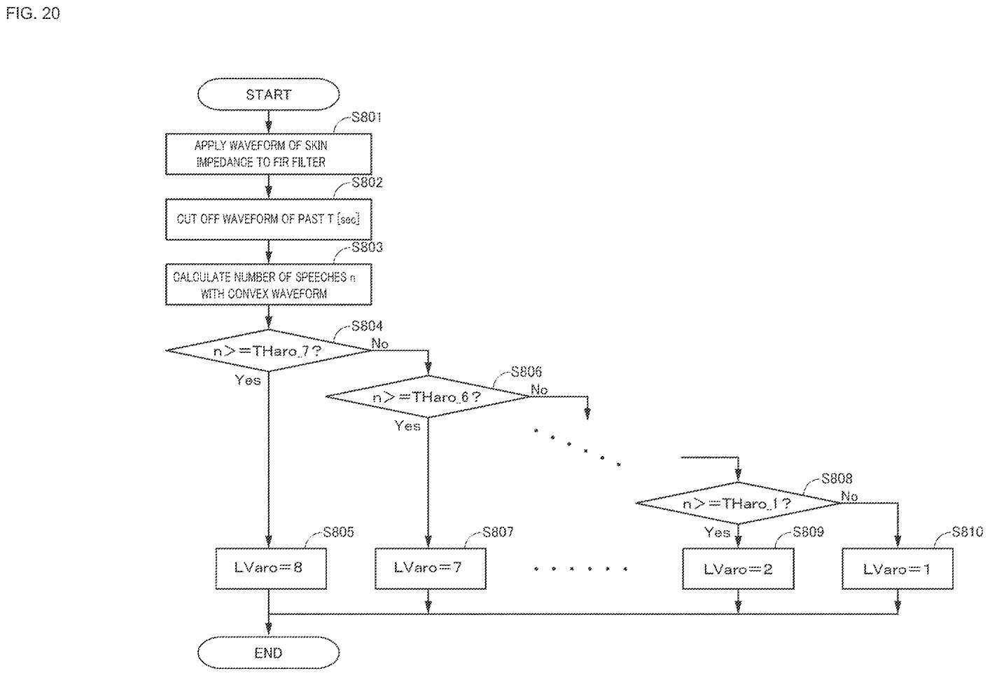

FIG. 20 is a flowchart illustrating a process of calculating the degree of arousal (hereinafter referred to as an arousal degree LVaro: aro means arousal) serving as state information based on an electrodermal response. It is necessary to appropriately set T and THaro_7 to THaro_1 which are integers and are used for the process of calculating the arousal degree LVaro. For example, T=600·THaro_i=i*5+30 is set. Also, for example, THaro_7=7*5+30=65 is set.

First, in step S801, a waveform of skin impedance is applied to a finite impulse response (FIR) filter. Subsequently, in step S802, a waveform of a past T [sec] is cut off. Subsequently, in step S803, the number of speeches n with a convex waveform is calculated.

Subsequently, in step S804, it is determined whether n≥THaro_7 is satisfied. When n≥THaro_7 is satisfied, the process proceeds to step S805 (Yes in S804), the arousal degree LVaro=8 is calculated.

Conversely, when n≥THaro_7 is not satisfied in step S804, the process proceeds to step S806 (No in step S804). In step S806, it is determined whether n≥THaro_6 is satisfied. When n≥THaro_6 is satisfied, the process proceeds to step S807 (Yes in step S806) and the arousal degree LVaro=7 is calculated. In this way, as long as n≥THaro_i is not satisfied, THaro_i gradually decreased and the comparison determination is repeated.

Then, when n≥THaro_1 is satisfied in step S808, the process proceeds to step S809 (Yes in step S808) and the arousal degree LVaro=2 is calculated. When n≥THaro_1 is not satisfied, the process proceeds to step S810 (No in step S808) and the arousal degree LVaro=1 is calculated. In this way, the arousal degree LVaro can be calculated.

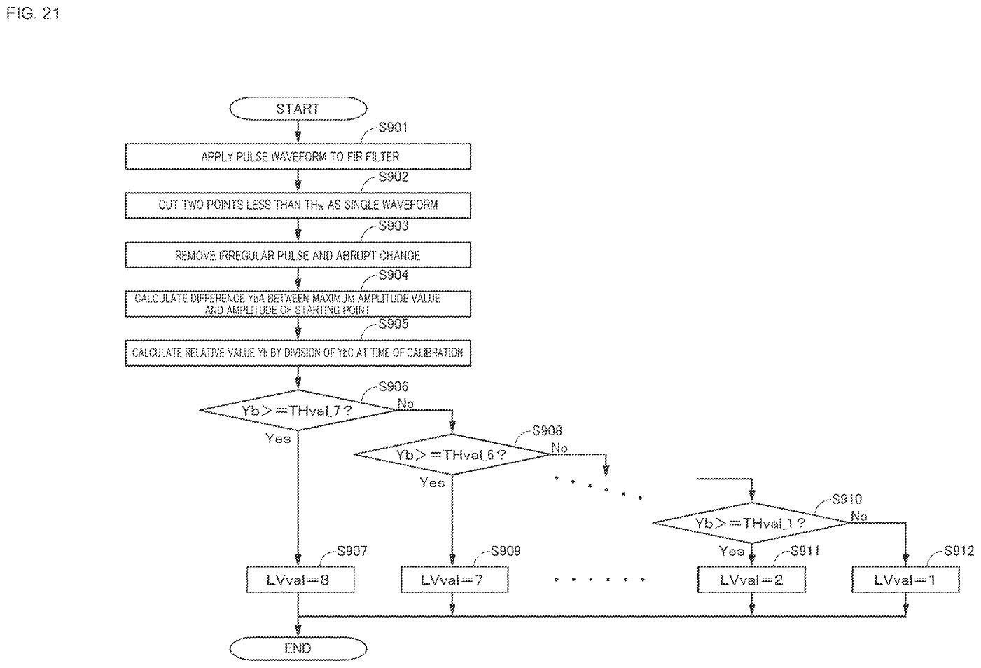

Next, a process of calculating the degree of pleasure or displeasure (hereinafter referred to as pleasure or displeasure degree LVval: val means valence) as state information based on a pulse wave will be described with reference to the flowchart of FIG. 21. It is necessary to appropriately set T and THval_7 to THval_1 which are integers and are used for a process of calculating the pleasure or displeasure degree LVval. For example, THval_i=i*0.15+0.25 is set. Also for example, THval_7=7*0.15+0.25=1.3 is set.

First, in step S901, the waveform of a pulse wave is applied to the FIR filter. Subsequently, in step S902, two points less than THw is cut as a single waveform. Subsequently, in step S903, an irregular pulse and an abrupt change are removed. Subsequently, in step S904, a difference YbA between a maximum amplitude value and an amplitude of a starting point is calculated. Subsequently, in step S905, a relative value Yb is calculated by division of YbC at the time of calibration.

Subsequently, in step S906, it is determined whether a relative value Yb≥THval_7 is satisfied. When Yb≥THval_7 is satisfied, the process proceeds to step S907 (Yes in S906) and the pleasure or displeasure degree LVval=8 is calculated.

Conversely, when the relative value Yb≥THval_7 is not satisfied in step S906, the process proceeds to step S908 (No in step S906). In step S908, it is determined whether the relative value Yb≥THval_6 is satisfied. When Yb≥THval_6 is satisfied, the process proceeds to step S909 (Yes in S908) and the pleasure or displeasure degree LVval=7 is calculated.

In this way, as long as the relative value Yb≥THval_i is not satisfied, i of THval_i gradually decreased and the comparison determination is repeated.

In step S910, when Yb≥THval_1 is satisfied, the process proceeds to step S911 (Yes in step S910) and pleasure or displeasure degree LVval=2 is calculated. Conversely, when Yb≥THval_1 is not satisfied in step S910, the process proceeds to step S912 (No in step S910) and pleasure or displeasure degree LVval=1 is calculated. In this way, the pleasure or displeasure degree LVval can be calculated.

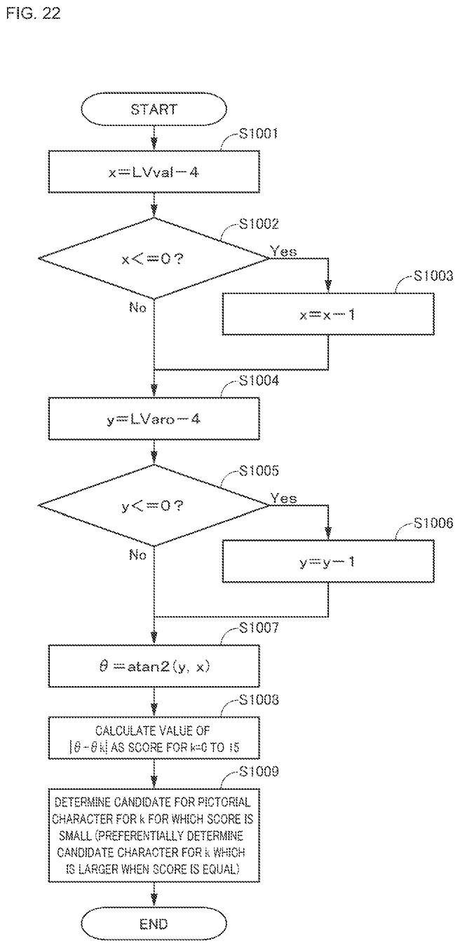

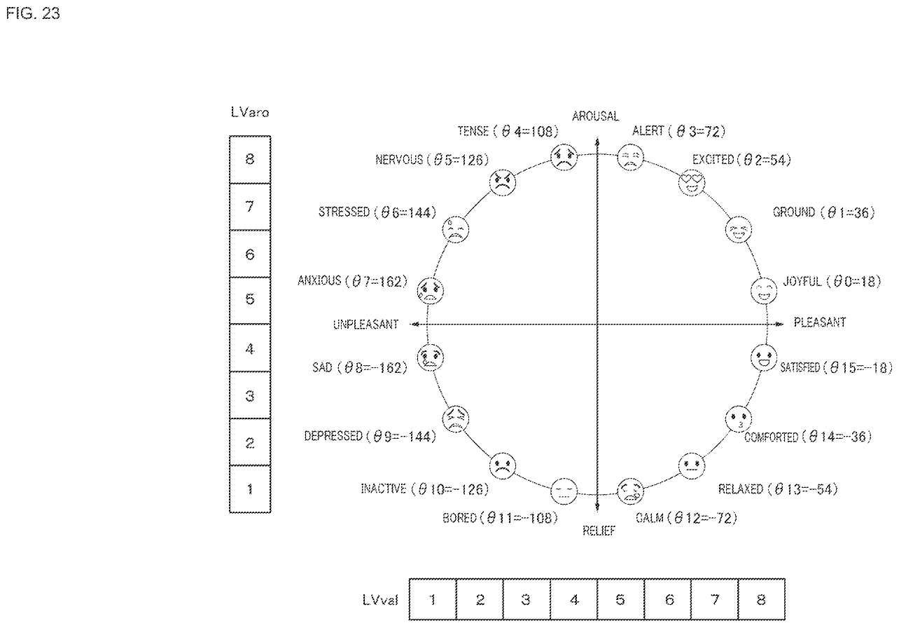

Next, a process of determining candidates for an end portion based on the arousal degree LVaro and the pleasure or displeasure degree LVval which are the state information will be described with reference to the flowchart of FIG. 22 and the circumflex model of FIG. 23. This process is a process performed by the end portion candidate determination unit 205 in the information processing device 200 operating in the terminal device 100 of the user receiving the state information sent from the device of the sending/receiving partner. As illustrated in FIG. 23, the circumflex model for emotions and pictorial characters are associated in advance. To map the pictorial characters to the circumflex model based on a ratio between the arousal degree LVaro and the pleasure or displeasure degree LVval, a tan is used. In disposition, the pictorial characters are disposed in order from a pictorial character indicating a closest emotion in accordance with the ratio between the arousal degree LVaro and the pleasure or displeasure degree LVval.

First, in step S1001, x is calculated with x=LVval−4 using the pleasure or displeasure degree. Subsequently, in step S1002, it is determined whether x<0 is satisfied. When x<0 is satisfied, the process proceeds to step S1003 (Yes in step S1002) and x is calculated as x=x−1.

After step S1003 and when x<0 is not satisfied in step S1002, y is calculated with y=LVaro−4 in step S1004. Subsequently, in step S1005, it is determined whether y<0 is satisfied. When y<0 is satisfied, the process proceeds to step S1006 (Yes in step S1005) and y is calculated as x=x−b 1.

After step S1006 and when x<0 is not satisfied in step S1005, θ is calculated from θ=a tan 2(y, x) in step S1007. Subsequently, in step S1008, an absolute value of θ−θk is calculated as a score for k=0 to 15.

In step S1009, as illustrated in FIG. 23, an end expression corresponding to k for which the score is small is determined as a candidate for the end portion.

In steps 1001 to 1003 of the flowchart of FIG. 22, a process of adjusting coordinates to cause the value of the pleasure or displeasure degree LVval to correspond to the circumflex model is performed. In steps 1004 to 1006, a process of adjusting coordinates to cause the value of arousal degree LVaro to correspond to the circumflex model.

In this way, the pictorial characters representing facial expressions and user states can be caused to correspond based on the arousal degree LVaro and the pleasure or displeasure degree LVval. Here, the matching relation illustrated in FIG. 23 is merely exemplary and the present technology is not limited to the matching relation.

By changing a method of mapping the pictorial characters to the circumflex model, for example, only one of the arousal degree and the pleasure or displeasure degree may be disposed on one axis.

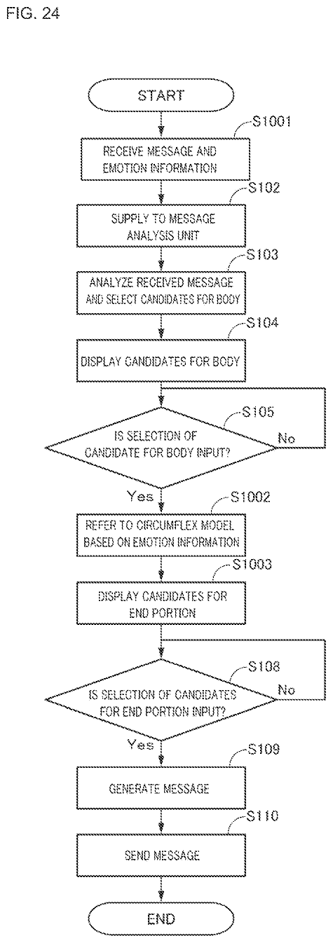

The flowchart of FIG. 24 is a flowchart illustrating a process in the information processing device 200 operating in the terminal device 100 of the user. In the flowchart of FIG. 24, the same reference numerals are given to similar processes to those of the flowchart of FIG. 6 and description thereof will be omitted.

First, in step S1001, the message and the state information from the sending/receiving partner are received. When the candidates for the body are displayed and a candidate for the body is selected by the user, the candidates for the end portion are determined with reference to the circumflex model based on the state information in step S1002. In step S1003, the candidates for the end portion determined based on the state information are displayed on the display unit 105.

According to the sixth method, for example, it is possible to easily compose and send an outgoing message to which the end portion appropriate for an emotional state of the sending/receiving partner is added. In the above-described description, the side of the terminal device 100 of the sending/receiving partner acquires the state information and sends the state information along with the message to the terminal device 100 of the user. However, the sensor information acquired by the terminal device 100 of the sending/receiving partner may be sent along with the message to the terminal device 100 of the user, and the information processing device 200 may acquire the state information from the sensor information.

The sixth method can be performed not only based on the sending/receiving partner but also user state information of the terminal device 100.

### [1-5-7. Seventh Method of Determining Candidates for End Portion]

Next, a seventh method of determining candidates for an end portion will be described. The seventh method is determined based on sensor information acquired by a sensor included in the terminal device 100 of the user.

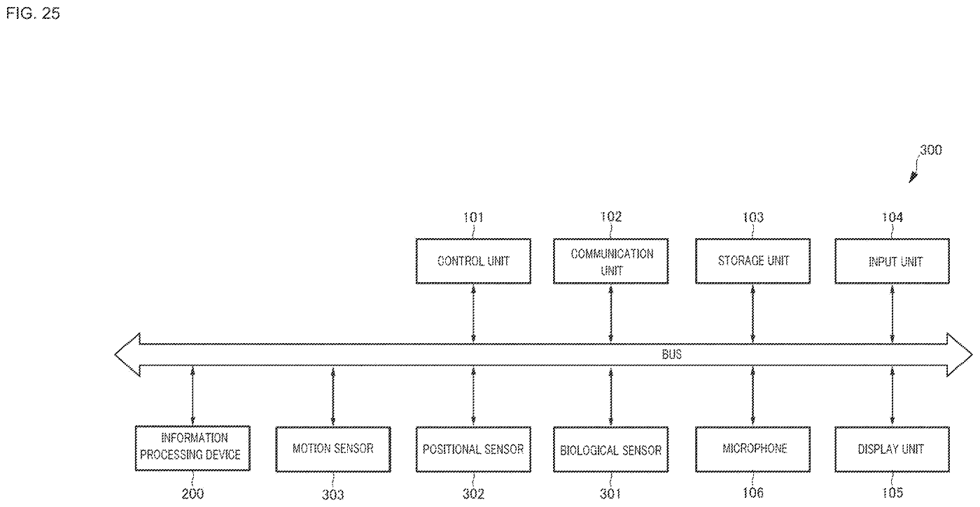

FIG. 25 is a block diagram illustrating a configuration of a terminal device 300 that performs the seventh method. The terminal device 300 includes a biological sensor 301, a positional sensor 302, and a motion sensor 303.

The biological sensor 301 is any of various sensors capable of acquiring biological information of a user and is, for example, a heart rate sensor, a blood pressure sensor, a perspiration sensor, a body temperature sensor, or the like. Additionally, any sensor may be used as long as the sensor can acquire biological information of the user.

The positional sensor 302 is a sensor such as a global positioning system (GPS), a global navigation satellite system (GNSS), Wi-Fi, or simultaneous localization and mapping (SLAM) capable of detecting a position of the user. Additionally, any sensor may be used as long as the sensor can detect a position of the user.

The motion sensor 303 is a sensor such as an acceleration sensor, an angular velocity sensor, a gyro sensor, a geomagnetic sensor, or an atmospheric pressure sensor capable of detecting a motion (a moving speed, a kind of motion, or the like) of the user. Additionally, any sensor may be used as long as the sensor can detect a motion of the user.

The information processing device 200 may include the biological sensor 301, the positional sensor 302, and the motion sensor 303. Further, the terminal device may be configured to acquire sensor information from an external sensor device.

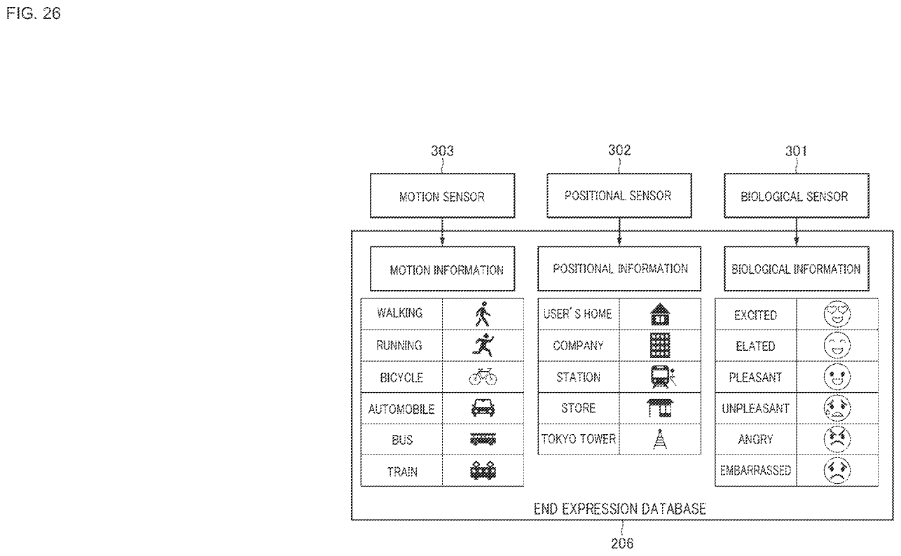

The end portion candidate determination unit 205 of the information processing device 200 determines candidates for an end portion based on sensor information from any of the above-described various sensors. For example, as illustrated in FIG. 26, it is necessary to associate end expressions with biological information by the biological sensor 301, positional information by the positional sensor 302, and motion sensor by the motion sensor 303 in advance in the end expression database 206. A method for correspondence of the biological information and the end expressions may be the above-described sixth method.

In the example of FIG. 26, a pictorial character of a home with regard to positional information “user's home,” a pictorial character of a building with regard to positional information “workplace,” a pictorial character of Tokyo Tower with regard to positional information “Tokyo Tower,” and the like are associated. A moving speed indicating motion information is associated with a pictorial character. For example, when a moving speed of the user is equal to or less than a predetermined first speed, the user is assumed to be walking and a pictorial character for a walking person is associated. When the moving speed of the user is equal to or greater than a predetermined second speed and equal to or less than a third speed, the user is assumed to be running, a pictorial character for a running person is associated. When the moving speed of the user is equal to or greater than the predetermined third speed, the user is assumed to be boarding a vehicle to move, a pictorial character such as a car or a train is associated. An action of the user may be recognized using machine learning from sensor data of an acceleration sensor, an angular velocity sensor, a geomagnetic sensor, an atmospheric pressure sensor, or the like, and the action may be associated with a pictorial character or the like.

The end portion candidate determination unit 205 determines end expressions corresponding to the sensor information as candidates for an end portion with reference to the end expression database 206 based on the sensor information acquired from the biological sensor 301, the positional sensor 302, and the motion sensor 303.

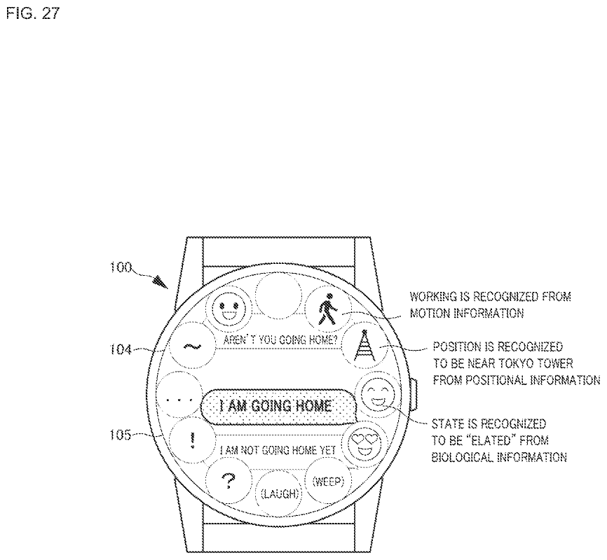

For example, when “The user is walking and moving near Tokyo Tower and his or her emotion is ‘Elated’” is recognized from the state information, the positional information, and the motion information, as illustrated in FIG. 27, a pictorial character for Tokyo Tower, a pictorial character for walking, and a pictorial character for a smiling face are preferentially displayed on the display unit 105.

According to the seventh method, the user can easily compose an outgoing message to which the end portion is added in accordance with a state when the user composes the outgoing message.

### [1-5-8. Eighth Method of Determining Candidates for End Portion]

Next, an eighth method of determining candidates for an end portion will be described. The eighth method is a method of determining candidates for an end portion in accordance with a body determined through a voice recognition function.

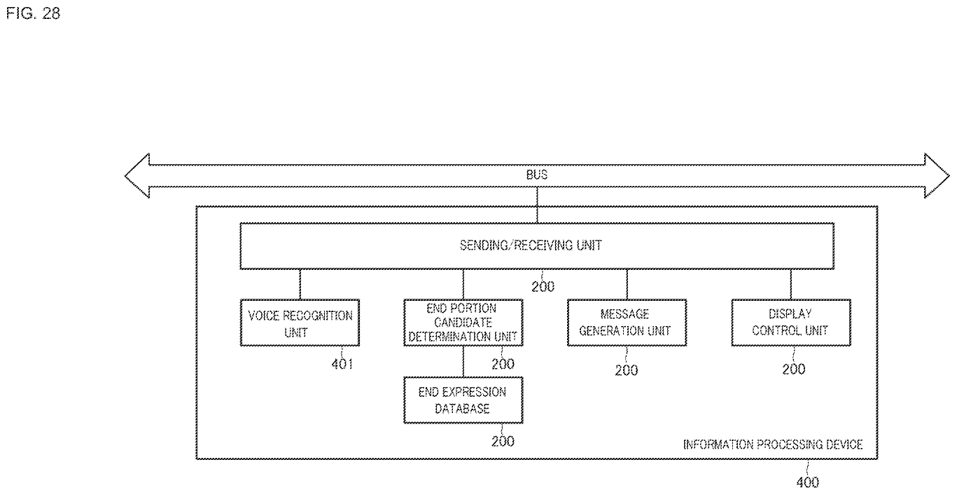

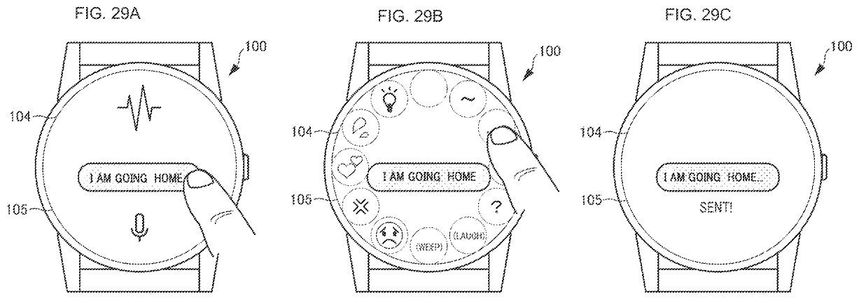

FIG. 28 is a block diagram illustrating a configuration of an information processing device 400 for realizing the eighth method. The information processing device 400 includes a voice recognition unit 401. The voice recognition unit 401 recognizes a voice input via the microphone 106 through a known voice recognition function and determines a character string that forms a body. The determined body is displayed on the display unit 105, as illustrated in FIG. 29A. In the eighth method, the character string recognized by the voice recognition unit 401 is a body. Therefore, it is not necessary to display candidates for the body on the display unit 105.

The end portion candidate determination unit 205 determines candidates for the end portion which is added to the body determined by the voice recognition unit 401. The candidates for the end portion can be determined using any of the above-described first to seventh methods. The determined candidates for the end portion are displayed in the circular state substantially centering on the body on the display unit 105, as illustrated in FIG. 29B. When the user selects any candidate for the end portion an outgoing message to which the end portion is added is generated and sent, as illustrated in FIG. 29C.

According to the eighth method, the end portion can also be added to the body determined through the voice input to compose a message. In general, a special character or the like cannot be input in the voice input. However, according to the present technology, a special character or the like can be included in a voice-input message.

In recent years, technologies for estimating emotions of people from voices have been put to practical use. A feature value in which a meter such as a pitch (a height), an intonation, a rhythm, a pause, and the like of a voice is mainly extracted from input voice data and state information is output based on an emotional recognition model generated in accordance with a general machine learning scheme. A scheme such as deep learning including a portion in which the feature value is extracted may be used.

### 2. Modification Examples

The embodiments of the present technology have been described specifically, but the present technology is not limited to the above-described embodiments and various modifications can be made based on the technical ideas of the present technology.

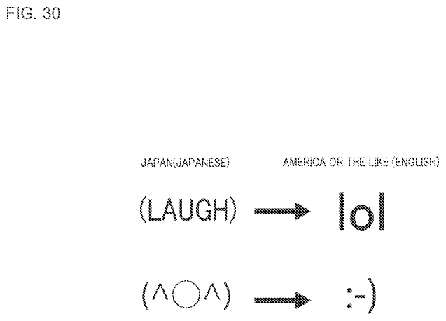

The present technology can also be applied to a message of a foreign language other than Japanese. As illustrated in FIG. 30, it is necessary to localize an end portion in accordance to each language, a culture of each nation, or the like in some cases.

The terminal device 100 is not limited to a wristwatch type wearable device and a glasses type wearable device may be used. In the case of a glasses type wearable device, the present technology may be able to be used by a visual line input.

The terminal device 100 may be any device such as a smartphone, a tablet terminal, a personal computer, a portable game device, or a projector as long as the device can compose a message. For example, when the present technology is applied to a smartphone or a tablet terminal, it is not necessary to display icons representing candidates for an end portion in a circular state, as illustrated in FIG. 7. As long as more icons can be disposed in a smaller area, any display method with high visibility may be used. When the display unit 105 of the terminal device 100 has a circular shape, the icons may be disposed in a circular state. When the display unit 105 has a rectangular shape, the icons may be disposed in a rectangular state. The shape of the display unit 105 may not match the disposition shape of the icons. For example, when the display unit 105 has a rectangular shape, the icons may be disposed in a circular state to surround a body. According to the present technology, candidates for an end portion are not displayed abundantly and randomly, but the candidates for the end portion appropriate for a message generated by the user are displayed. Therefore, a region in which the candidates for the end portion is small may be displayed and, for example, another region such as a region in which a message is displayed can be large.

The present technology is not limited to a so-called touch panel in which the display unit 105 and the input unit 104 are integrated. The display unit 105 and the input unit 104 may be configured separately. For example, a display serving as the display unit 105 and a so-called touch pad, a mouse, or the like serving as the input unit 104 may be used.

The candidates for the body are displayed as two options on the display unit 105, as described above. The candidates for the body are not limited to two options, but the candidates for the body may be three or more options. The present technology can also be applied to an end portion added to a body directly input by the user other than the selection. Further, the present technology can be applied not only to a response message to a received message but also to an outgoing message composed without the premise of a received message.

The first to eighth methods for determining the candidates for the end portion described in the embodiments may not be used independently, but may be used in combination.

The present technology can be configured as follows.
(1)

An information processing device including:

an end portion candidate determination unit configured to determine a plurality of candidates for an end portion that is added to an end of a body and forms a message along with the body.
(2)

The information processing device according to (1), wherein the candidates for the end portion are determined based on a past usage count.
(3)

The information processing device according to (1) or (2), wherein the candidates for the end portion are determined based on a matching relation with a keyword in the body.
(4)

The information processing device according to any one of (1) to (3), wherein the candidates for the end portion are determined based on similarity between the body and a sent message.
(5)

The information processing device according to any one of (1) to (4), wherein the candidates for the end portion are determined based on a state of the user.
(6)

The information processing device according to (1),

wherein the end portion includes a special character.
(7)

The information processing device according to (6), wherein the special character includes at least one of a symbolic character, a character indicating a figure, a pictorial character, and an emoticon.
(8)

The information processing device according to any one of (1) to (7), wherein the body is a sentence selected from a plurality of candidates for the body presented to the user.
(9)

The information processing device according to any one of (1) to (8), wherein the body is a sentence determined and presented based on a voice through voice recognition.
(10)

The information processing device according to any one of (1) to (9), further including a display control unit configured to display the candidates for the end portion and the body on a display unit of a terminal device.
(11)

The information processing device according to (10), wherein the candidates for the end portion are displayed as icons on the display unit.
(12)

The information processing device according to (11), wherein the plurality of icons are displayed and arranged around the body.
(13)

The information processing device according to (11) or (12), wherein the icons are displayed based on a matching relation among a rank of a usage count of the end portion, a circumflex model for emotions, and a keyword of the body.
(14)

The information processing device according to (13), wherein an icon indicating an instruction not to add the end portion to the body in a display aspect similar to the icon indicating the candidate for the end portion is displayed on the display unit.
(15)

The information processing device according to any one of (12) to (14), wherein the display unit includes a touch panel function, and an operation of selecting one body from a plurality of candidates for one of said body and an operation of selecting one end portion from the plurality of candidates for one of said end portion are continuously performed with a single touch on the display unit.
(16)

The information processing device according to any one of (12) to (15), wherein the terminal device is a wearable device.
(17)

The information processing device according to any one of (1) to (16), further including a message generation unit configured to generate the message to be sent by adding the end portion to the body.
(18)

An information processing method including: determining a plurality of candidates for an end portion that is added to an end of a body and forms a message along with the body.
(19)

An information processing program causing a computer to execute an information processing method including: determining a plurality of candidates for an end portion that is added to an end of a body and forms a message along with the body.

### REFERENCE SIGNS LIST

100 Terminal device
200 Information processing device
205 End portion candidate determination unit
207 Message generation unit
208 Display control unit

1. An information processing device comprising:
an end portion candidate determination unit configured to determine a plurality of candidates for an end portion that is added to an end of a body and forms a message along with the body.

2. The information processing device according to claim 1,
wherein the candidates for the end portion are determined based on a past usage count.

3. The information processing device according to claim 1, wherein the candidates for the end portion are determined based on a matching relation with a keyword in the body.

4. The information processing device according to claim 1,
wherein the candidates for the end portion are determined based on similarity between the body and a sent message.

5. The information processing device according to claim 1,
wherein the candidates for the end portion are determined based on at least one of a state of the user and the state of a message sending/receiving partner.

6. The information processing device according to claim 1,
wherein the end portion includes a special character.

7. The information processing device according to claim 6,
wherein the special character includes at least one of a symbolic character, a character indicating a figure, a pictorial character, and an emoticon.

8. The information processing device according to claim 1,
wherein the body is a sentence selected from a plurality of candidates for the body presented to the user.

9. The information processing device according to claim 1,
wherein the body is a sentence determined and presented based on a voice through voice recognition.

10. The information processing device according to claim 1, further comprising:
a display control unit configured to display the candidates for the end portion and the body on a display unit of a terminal device.

11. The information processing device according to claim 10,
wherein the candidates for the end portion are displayed as icons on the display unit.

12. The information processing device according to claim 11,
wherein the plurality of icons are displayed and arranged around the body.

13. The information processing device according to claim 11,
wherein the icons are displayed based on a matching relation among a rank of a usage count of the end portion, a circumflex model for emotions, and a keyword of the body.

14. The information processing device according to claim 13,
wherein an icon indicating an instruction not to add the end portion to the body in a display aspect similar to the icon indicating the candidate for the end portion is displayed on the display unit.

15. The information processing device according to claim 12,
wherein the display unit includes a touch panel function, and an operation of selecting one of said body from a plurality of candidates for the body and an operation of selecting one of said end portion from the plurality of candidates for the end portion are continuously performed with a single touch on the display unit.

16. The information processing device according to claim 12,
wherein the terminal device is a wearable device.

17. The information processing device according to claim 1, further comprising:
a message generation unit configured to generate the message by adding the end portion to the body.

18. An information processing method comprising:
determining a plurality of candidates for an end portion that is added to an end of a body and forms a message along with the body.

19. An information processing program causing a computer to execute an information processing method including:
determining a plurality of candidates for an end portion that is added to an end of a body and forms a message along with the body.
